(19) United States
(12) Patent Application Publication
(10) Pub. No.: US 2014/0177816 A1
(43) Pub. Date: Jun. 26, 2014

(54) CALLBACK SYSTEM AND METHOD AND COMMUNICATION TERMINAL USING THE SAME

(71) Applicants: HON HAI PRECISION INDUSTRY CO., LTD., New Taipei (TW); FU TAI HUA INDUSTRY (SHENZHEN) CO., LTD., Shenzhen (CN)

(72) Inventor: XI LIN, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/949,241

(22) Filed: Jul. 24, 2013

(30) Foreign Application Priority Data
Dec. 25, 2012 (CN) 2012105692315

(51) Int. Cl. H04M 3/42

(52) U.S. Cl. CPC H04M 3/42195
USPC 379/210.01

(57) ABSTRACT

A callback system and method are provided. The callback method includes steps as followed: determining whether or not a phone number of a call request is one of the predetermined phone numbers in the list when the communication terminal receives the call request, hanging up the call request and dialing back the phone number of the call request when the phone number of the call request is one of the predetermined phone numbers in the list. A communication terminal with a callback function is also provided.

### BACKGROUND

1. Technical Field

The present disclosure relates to callback systems, and particularly to a callback system and a method, and a communication terminal using the same.

2. Description of Related Art

After a communication terminal receives a call request, users may choose to hang up and dial back the calling phone number when there is a better calling rate for callback. However, it is inconvenient and complex for the user himself to determine whether there is the better calling rate or not.

Therefore, what is needed is a callback system to overcome the above described limitations.

### BRIEF DESCRIPTION OF THE DRAWING

FIG. 1 is a schematic diagram of a callback system in accordance with an exemplary embodiment.

FIG. 2 shows a list recording a number of predetermined phone numbers.

FIG. 3 is a flowchart of a callback method implemented by the callback system of FIG. 1, in accordance with an exemplary embodiment.

### DETAILED DESCRIPTION

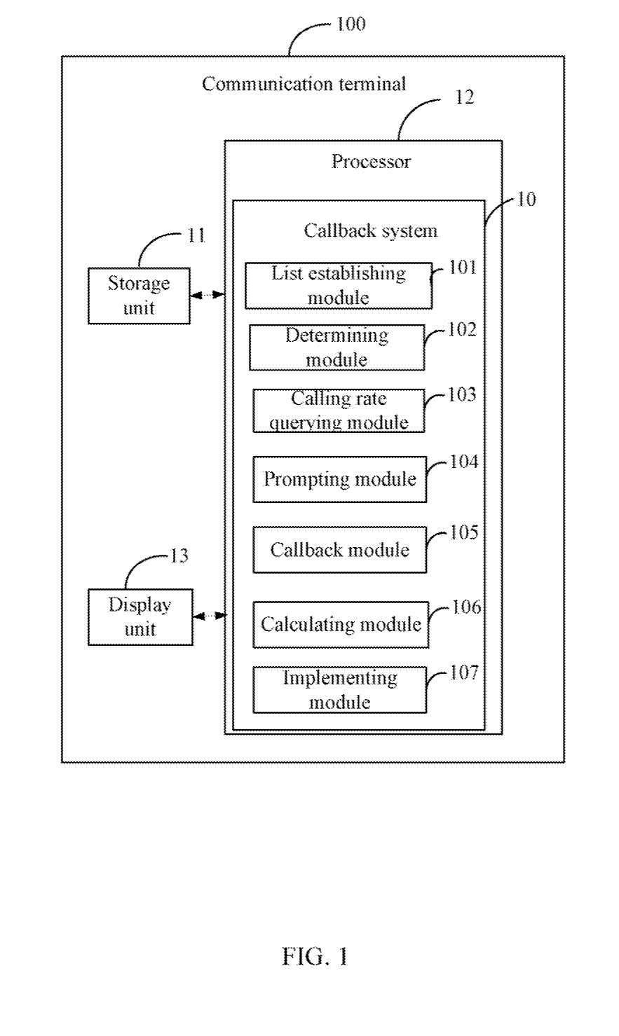

FIG. 1 shows a callback system 10 being run in a communication terminal 100. The communication terminal 100 includes a storage unit 11, a processor 12 and a display unit 13. The storage unit 11 stores a list which records a number of predetermined phone numbers.

The processor 12 includes a determining module 102, a callback module 105, a calling rate querying module 103, a prompting module 104, and an implementing module 107. The determining module 102 determines whether or not a phone number of a call request is one of the predetermined phone numbers in the list when the communication terminal 100 receives the call request. The callback module 105 hangs up the call request and dials back the phone number of the call request when the phone number of the call request is one of the predetermined phone numbers in the list. The callback module 105 further prompts the user in a predetermined prompting manner after the call request was hung up and was dialed back by the communication terminal 100. In one embodiment, the predetermined prompting manner may be a prompting music, a vibration or a combination thereof. The calling rate querying module 103 queries a first calling rate of the call, which is initiated from an external communication terminal, and a second calling rate of the call, which is initiated from the communication terminal 100 from the telecommunications operators, and determines whether or not the first calling rate is higher than the second calling rate when the phone number of the call request is not one of the predetermined phone numbers in the list. The prompting module 104 prompts the user whether to select to dial back the phone number of the call request when the first calling rate is higher than the second calling rate. The callback module 105 further hangs up the call request, dials back the phone number of the call request when the user selects to dial back the phone number of the call request. The implementing module 107 processes the call in other means such as, answering/returning the call request in response to a user operation when the user does not select to dial back the phone number of the call request or the first calling rate is not higher than the second calling rate. In other embodiments, the implementing module 107 further processes the call request in other means in response to the operation of the user, when the phone number of the call request is not one of the predetermined phone numbers in the list, thereby omitting the calling rate querying module 103 and the prompting module 104.

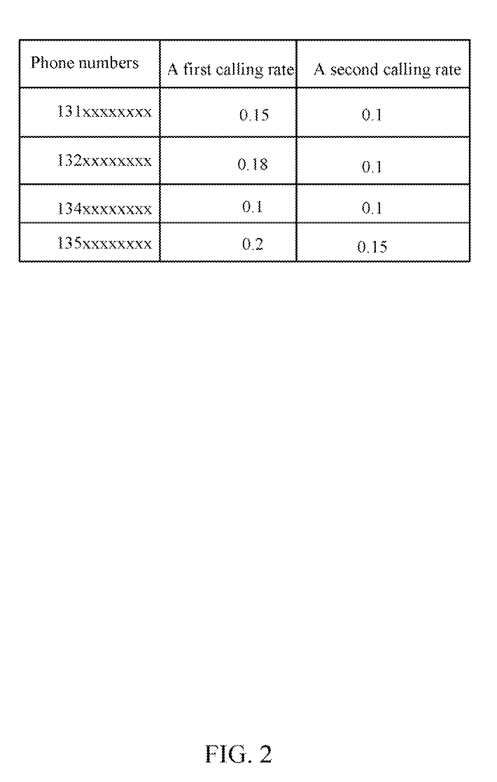

The processor 12 further includes a list establishing module 101. The list establishing module 101 establishes the list, and records the number of phone numbers in the list as predetermined phone numbers. The list establishing module 101 further records the first calling rate of the call, which is initiated from the external communication terminal, and records the second calling rate of the call which is initiated from the communication terminal 100 for each of the predetermined phone numbers. The user previously sets the first calling rate and the second calling rate for each of the predetermined phone numbers. As shown in FIG. 2, the list records the predetermined phone numbers, and the first calling rate and the second calling rate for each of the predetermined phone numbers.

The processor 12 further includes a calculating module 106. When the phone number of the call request is one of the predetermined phone numbers, the calling rate querying module 103 acquires the first calling rate and the second calling rate of the phone number of the call request from the list after the call which was dialed back by the communication terminal 100 has ended. The calculating module 106 calculates a difference between the first calling rate and the second calling rate and multiplies the difference by a call duration to obtain a call saving, and displays the call saving on the display unit 13. When the phone number of the call request is not one of the predetermined phone numbers, the calling rate querying module 103 acquires the first calling rate and the second calling rate of the phone number of the call request from the mobile telecommunications operator. The calculating module 106 calculates a difference between the first calling rate and the second calling rate and multiplies the difference by a call duration to obtain a call saving, and displays the call saving on the display unit 13. Thus, if the call saving is less than 0 that means the second calling rate is more than the first calling rate, the communication terminal 100 hangs up the call request and dials back the phone number will generate more call cost than the call request is initiated from the external communication terminal.

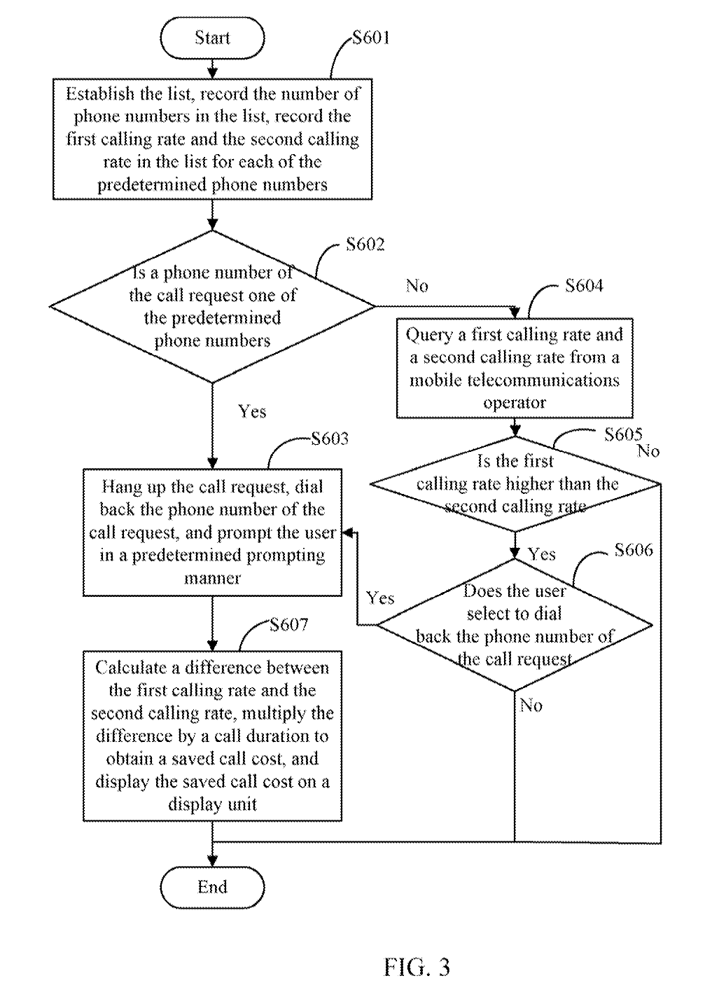

FIG. 3 is a flowchart of a callback method implemented by the callback system of FIG. 1, in accordance with an exemplary embodiment.

In step S601, the list establishing module 101 establishes the list, records the number of phone numbers in the list as the predetermined phone numbers, records the first calling rate of the call which is initiated from the external communication terminal, and records the second calling rate of the call which is initiated from the communication terminal 100 for each of the predetermined phone numbers.

In step S602, the determining module 102 determines whether or not a phone number of a call request is one of the predetermined phone numbers in the list when the communication terminal 100 receives the call request, if yes, the procedure goes to step S603, if no, the procedure goes to step S604.

In step S603, the callback module 105 hangs up the call request, dials back the phone number of the call request, and prompts the user in a predetermined prompting manner.

In step S604, the calling rate querying module 103 queries a first calling rate and a second calling rate from the mobile telecommunications operator.

In step S605, the calling rate querying module 103 determines whether or not the first calling rate is higher than the second calling rate, if yes, the procedure goes to step S606.

In step S606, the prompting module 104 prompts the user whether to select to dial back the phone number of the call request, if yes, the procedure goes to step S603.

In step S607, the calculating module 106 calculates a difference between the first calling rate and the second calling rate and multiplies the difference by a call duration to obtain a call saving, and displays the call saving on the display unit 13.

Although various embodiments have been specifically described, the disclosure is not to be construed as being limited thereto. Various changes or modifications may be made to the embodiments without departing from the scope and spirit of the disclosure.

What is claimed is:

1. A callback system for a communication terminal, wherein the communication terminal comprises a storage unit, the storage unit stores a list which records a plurality of predetermined phone numbers, comprising:
one or more processors; and
a plurality of modules to be executed by the one or more processors, wherein the plurality of modules comprises:
a determining module configured to determine whether or not a phone number of a call request is one of the predetermined phone numbers in the list when the communication terminal receives the call request; and
a callback module configured to hang up the call request and dial back the phone number of the call request when the phone number of the call request is one of the predetermined phone numbers in the list.

2. The callback system as described in claim 1, wherein the plurality of modules further comprises:
a calling rate querying module configured to query a first calling rate of a call which is initiated from an external communication terminal, and a second calling rate of the call which is initiated from the communication terminal from a mobile telecommunications operator when the phone number of the call request is not one of the predetermined phone numbers in the list;
the calling rate querying module further configured to judge whether or not the first calling rate is higher than the second calling rate; and
a prompting module configured to prompt a user whether to select to dial back the phone number of the call request when the first calling rate is higher than the second calling rate,
wherein the callback module is further configured to hang up the call request, and dial back the phone number of the call request when the user selects to dial back the phone number of the call request.

3. The callback system as described in claim 2, wherein the callback module is further configured to prompt the user in the predetermined prompting manner after the call request was hung up and was dialed back by the communication terminal.

4. The callback system as described in claim 2, wherein the list further records the first calling rate and the second calling rate for each of the predetermined phone numbers, the plurality of modules further comprises:
the calling rate querying module further configured to acquire the first calling rate and the second calling rate of the phone number of the call request from the list after the call which was dialed back by the communication terminal has ended when the phone number of the call request is one of the predetermined phone numbers; and
a calculating module configured to calculate a difference between the first calling rate and the second calling rate, multiply the difference by a call duration to obtain call saving, and display the call saving on a display unit.

5. The callback system as described in claim 2, wherein the plurality of modules further comprises:
the calling rate querying module further configured to acquire the first calling rate and the second calling rate of the phone number of the call request from the mobile telecommunications operator after the call which was dialed back by the communication terminal has ended when the phone number of the call request is not one of the predetermined phone numbers; and
a calculating module configured to calculate a difference between the first calling rate and the second calling rate, multiply the difference by a call duration to obtain a call saving, and display the call saving on a display unit.

6. The callback system as described in claim 4, wherein the plurality of module further comprises:
a list establishing module configured to establish the list, record the plurality of phone numbers in the list as predetermined phone numbers, and record the first calling rate and the second calling rate for each of the predetermined phone numbers.

7. A communication terminal with a callback function comprising:
a storage unit configured to store a list which records a plurality of predetermined phone numbers; and
a processor configured to determine whether or not a phone number of a call request is one of the predetermined phone numbers in the list when the communication terminal receives the call request, hang up the call request and dial back the phone number of the call request when the phone number of the call request is one of the predetermined phone numbers.

8. The communication terminal with a callback function as described in claim 7, wherein the processor is further configured to query a first calling rate of a call which is initiated from an external communication terminal, and a second calling rate of the call which is initiated from the communication terminal from a mobile telecommunications operator when the phone number of the call request is not one of the predetermined phone numbers in the list, judge whether or not the first calling rate is higher than the second calling rate, prompt a user whether to select to dial back the phone number of the call request when the first calling rate is higher than the second calling rate, hang up the call request, and dial back the phone number of the call request when the user selects to dial back the phone number of the call request.

9. The communication terminal with a callback function as described in claim 8, wherein the processor is further configured to prompt the user in the predetermined prompting manner after the call request was hung up and was dialed back by the communication terminal.

10. The communication terminal with a callback function as described in claim 8, wherein the list further records the first calling rate and the second calling rate for each of the predetermined phone numbers, the processor is further configured to acquire the first calling rate and the second calling rate of the phone number of the call request from the list after the call which was dialed back by the communication terminal has ended when the phone number of the call request is one of the predetermined phone numbers, calculate a difference between the first calling rate and the second calling rate, multiply the difference by a call duration to obtain a call saving, and display the call saving on a display unit.

11. The communication terminal with a callback function as described in claim 8, wherein the processor is further configured to acquire the first calling rate and the second calling rate of the phone number of the call request from the mobile telecommunications operator after the call which was dialed back by the communication terminal has ended when the phone number of the call request is not one of the predetermined phone numbers, calculate a difference between the first calling rate and the second calling rate, multiply the difference by a call duration to obtain a call saving, and display the call saving on a display unit.

12. The communication terminal with a callback function as described in claim 10, wherein the processor is further configured to establish the list, record the plurality of phone numbers in the list as the plurality of predetermined phone numbers, and record the first calling rate and the second calling rate for each of the predetermined phone numbers.

13. A callback method being run in a communication terminal, wherein the communication terminal comprises a storage unit, the storage unit stores a list which records a plurality of predetermined phone numbers, the method comprising:
determining whether or not a phone number of a call request is one of the predetermined phone numbers in the list when the communication terminal receives the call request; and
hanging up the call request and dialing back the phone number of the call request when the phone number of the call request is one of the predetermined phone numbers in the list.

14. The callback method as described in claim 13, further comprising:
querying a first calling rate of a call which is initiated from an external communication terminal, and a second calling rate of the call which is initiated from the communication terminal from a mobile telecommunications operator when the phone number of the call request is not one of the predetermined phone numbers in the list;
judging whether or not the first calling rate is higher than the second calling rate;
prompting a user whether to select to dial back the phone number of the call request when the first calling rate is higher than the second calling rate; and
hanging up the call request, and dialing back the phone number of the call request when the user selects to dial back the phone number of the call request.

15. The callback method as described in claim 14, further comprising:
prompting the user in the predetermined prompting manner after the call request was hung up and was dialed back by the communication terminal.

16. The callback method as described in claim 14, wherein the list further records the first calling rate and the second calling rate for each of the predetermined phone numbers, the method further comprises:
acquiring the first calling rate and the second calling rate of the phone number of the call request from the list after the call which was dialed back by the communication terminal has ended when the phone number of the call request is one of the predetermined phone numbers; and
calculating a difference between the first calling rate and the second calling rate, multiplying the difference by a call duration to obtain a call saving, and displaying the call saving on a display unit.

17. The callback method as described in claim 14, further comprising:
acquiring the first calling rate and the second calling rate of the phone number of the call request from the mobile telecommunications operator after the call which was dialed back by the communication terminal has ended when the phone number of the call request is not one of the predetermined phone numbers; and
calculating a difference between the first calling rate and the second calling rate, multiplying the difference by a call duration to obtain a call saving, and displaying the call saving on a display unit.

18. The callback method as described in claim 16, further comprising:
establishing the list;
recording the plurality of phone numbers in the list as the plurality of predetermined phone numbers; and
recording the first calling rate and the second calling rate for each of the predetermined phone numbers.
